(19) United States
(12) Patent Application Publication
(10) Pub. No.: US 2010/0321716 A1
(43) Pub. Date: Dec. 23, 2010

(54) IMAGE PROCESSING SYSTEM, CONTROL METHOD THEREOF, AND PROGRAM

(75) Inventor: Akinori Takeo, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/797,018

(22) Filed: Jun. 9, 2010

(30) Foreign Application Priority Data
Jun. 22, 2009 (JP) 2009-147949

(51) Int. Cl. G06K 15/02

(52) U.S. Cl. 358/1.14; 358/1.15

(57) ABSTRACT

This invention provides an image processing system in which upon reception of a predetermined event associated with a job executed by another image processing apparatus, an image processing apparatus that received the event suitably controls subsequent processes. To accomplish this, this invention provides an image processing system where the first and second image processing apparatus are connected to be able to communicate with each other, the first image processing apparatus accepts, when the second image processing apparatus notifies the first image processing apparatus of occurrence of the predetermined event, an instruction for a job in which the predetermined event has occurred, from the user-authenticated user, and can send the accepted instruction to the second image processing apparatus.

### BACKGROUND OF THE INVENTION

1. Field of the Invention

The present invention relates to an image processing system which communicates with an external apparatus, a control method thereof, and a program.

2. Description of the Related Art

In a recent office environment, it is a common practice to selectively use a plurality of MFPs and printers connected via a network in accordance with intended purposes and states of the apparatus. Also, it is possible to parallelly execute a plurality of processes using a plurality of apparatus at the same time. For example, in one use method, an MFP copies an original during print processing of a printer, or originals in large quantities are distributed to a plurality of MFPs and are parallelly scanned.

As elevation of security awareness, access control based on user authentication is executed not only in information processing apparatus such as personal computers but also in apparatus such as MFPs and printers. After user authentication, access control of various MFP functions and stored data can be executed for a user who has logged in to the MFP. For example, a print, copy, FAX sending/receiving, and storage document jobs associated with a given user can be executed by only that user, who can also execute job operations such as cancel and stop operations. Furthermore, only the associated user can refer to attributes such as names of jobs and logs such as job processing results.

Furthermore, when a user executes a job operation from another apparatus via a network, or when he or she refers to attributes or logs, the aforementioned access control has to be validated as in the case in which he or she directly logs in to an MFP to execute the job operation or refer to the above information. That is, when the user executes a job operation or refers to given information via the network, user authentication information acquired by another apparatus is sent to a corresponding MFP. The MFP executes the same access control as that when the user directly logs in using the received user authentication information.

On the other hand, as a method of notifying a user who input a print instruction of a print result via a network, Japanese Patent Laid-Open No. 2007-280045 has proposed a technique which manages a current login apparatus of the user who input the print instruction using client and server apparatus. Upon notifying the user of the print result, a printing apparatus inquires the server apparatus about the current login apparatus of the user who input the print instruction, and sends the print result to the current login apparatus. In Japanese Patent Laid-Open No. 2007-280045, upon notifying the user of the print result, the current login apparatus of that user is checked, and the print result is sent to that login apparatus, thus allowing to quickly and surely notify the user who input the print instruction of the print result.

However, when the print result is simply sent to the login apparatus of the user, the apparatus which received the sent print result cannot judge whether or not to allow the current login user to refer to the received information. When print processing is interrupted due to out of paper or memory full, the apparatus which received the sent print result cannot judge whether or not the current login user can execute a job operation.

### SUMMARY OF THE INVENTION

The present invention enables realization of an image processing system in which when a given image processing apparatus receives a predetermined event associated with a job which is executed by another image processing apparatus, the image processing apparatus which received the event suitably controls subsequent processes, a control method thereof, and a program.

One aspect of the present invention provides an image processing system in which a first image processing apparatus and a second image processing apparatus are connected to be able to communicate with each other, the first image processing apparatus comprising: an authentication unit that authenticates a user, and allows a user-authenticated user to log in to the first image processing apparatus; an accepting unit that accepts, when the second image processing apparatus notifies occurrence of the predetermined event, an instruction for the job in which the predetermined event has occurred, from the user-authenticated user; and a sending unit that sends, when the accepting unit accepts the instruction, the instruction to the second image processing apparatus, and the second image processing apparatus comprising: an event notifying unit that notifies, when the predetermined event has occurred in the job executed in the second image processing apparatus, the first image processing apparatus of occurrence of the predetermined event; and a control unit that controls the job in which the predetermined event has occurred, based on the instruction sent by the sending unit.

Another aspect of the present invention provides a control method of an image processing system in which a first image processing apparatus and a second image processing apparatus are connected to be able to communicate with each other, the method comprising: controlling the first image processing apparatus by controlling an authentication unit to authenticate a user, and to allow a user-authenticated user to log in to the first image processing apparatus, controlling an accepting unit to accept, when the second image processing apparatus notifies occurrence of the predetermined event, an instruction for the job in which the predetermined event has occurred, from the user-authenticated user, and controlling a sending unit to send, when the instruction is accepted in the controlling the accepting unit, the instruction to the second image processing apparatus; and controlling the second image processing apparatus by controlling an event notifying unit to notify, when the predetermined event has occurred in the job executed in the second image processing apparatus, the first image processing apparatus of occurrence of the predetermined event, and controlling a control unit to control the job in which the predetermined event has occurred, based on the instruction sent in the controlling the ending unit.

Still another aspect of the present invention provides a computer-readable storage medium storing a computer program for making a computer execute the control method of the image processing system.

Further features of the present invention will be apparent from the following description of exemplary embodiments with reference to the attached drawings.

### BRIEF DESCRIPTION OF THE DRAWINGS

FIG. 1 is a diagram showing the overall arrangement of an image processing system 1000 according to an embodiment of the present invention;

FIG. 2 is a block diagram showing an example of the arrangement of an MFP according to the embodiment;

FIG. 3 is a flowchart showing the processing sequence for requesting a job state change notification according to the embodiment;

FIG. 4 is a view showing an example of the configuration of a sending packet used to request the job state change notification according to the embodiment;

FIG. 5 is a flowchart showing the processing sequence executed upon reception of the job state change notify request according to the embodiment;

FIG. 6 is a flowchart showing the processing sequence executed upon occurrence of an event during execution of a job according to the embodiment;

FIG. 7 is a view showing an example of the configuration of an event notify sending packet according to the embodiment;

FIG. 8 is a flowchart showing the processing sequence executed upon reception of an event notification according to the embodiment;

FIG. 9 is a flowchart showing the processing sequence of detail display processing of event notification contents and job operation processing according to the embodiment;

FIG. 10 is a flowchart showing the processing sequence executed upon searching for a job substitute destination according to the embodiment; and

FIG. 11 is a table showing an example of job attributes and capability information required to judge a job substitute destination according to the embodiment.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

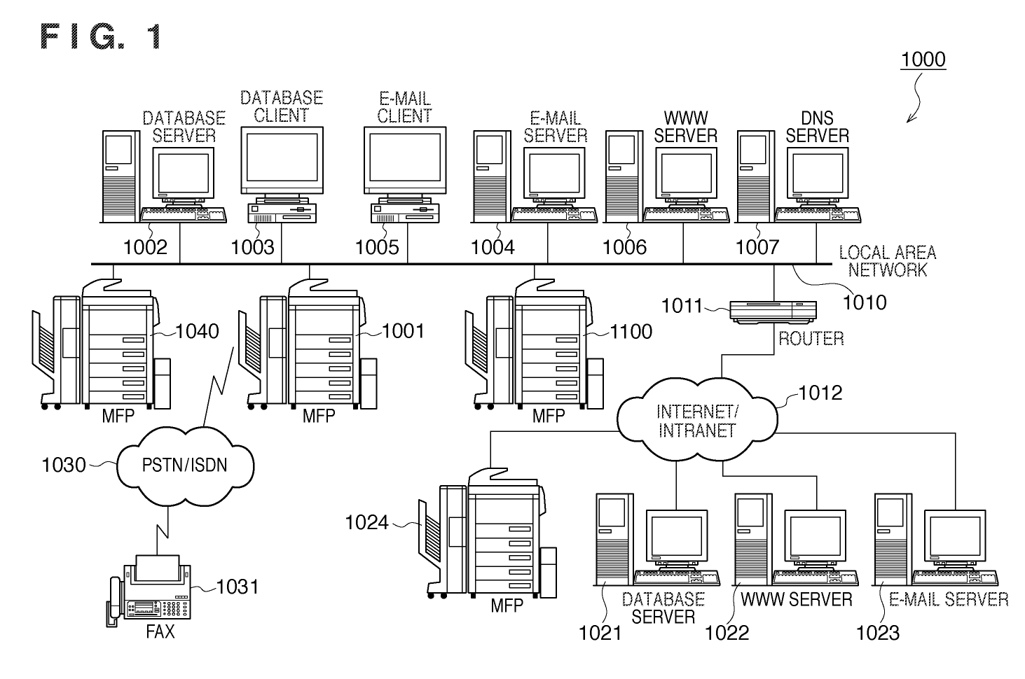

The arrangement of an image processing system 1000 according to an embodiment of the present invention will be described first with reference to FIG. 1. In the image processing system 1000, a plurality of various apparatus are connected to be able to communicate with each other via a LAN 1010, router 1011, Internet/intranet 1012, PSTN/ISDN 1030. Reference numeral 1001 denotes an MFP according to this embodiment, which includes a scanner and printer. The MFP 1001 can output an image read using the scanner onto the LAN 1010, and can print an image received via the LAN 1010 using the printer (to form an image on a sheet). That is, the MFP 1001 can serve as an image reading apparatus and also as an image processing apparatus. Also, the MFP 1001 can send an image read using the scanner onto the PSTN/ISDN 1030 using a FAX sending function, and can print out an image received via the PSTN/ISDN 1030 using the printer.

Reference numeral 1002 denotes a database server, which manages binary and multi-valued image data read by the MFP 1001 as a database. Reference numeral 1003 denotes a database client of the database server 1002. The database client 1003 can browse or search images stored in the database server 1002. Reference numeral 1004 denotes an e-mail server, which can receive an image read by the MFP 1001 as data attached to an e-mail message. Reference numeral 1005 denotes a client of the e-mail server 1004. The client 1005 can receive and browse a mail message received by the e-mail server 1004, and can send an e-mail message.

Reference numeral 1006 denotes a WWW server which provides HTML documents to respective apparatus connected to the LAN 1010. The MFP 1001 can print out HTML documents provided by the WWW server 1006. Reference numeral 1007 denotes a DNS server. The router 1011 connects the LAN 1010 to the Internet/intranet 1012. To the Internet/intranet 1012, a database server 1021, WWW server 1022, e-mail server 1023, and MFP 1024 are connected. On the other hand, the MFP 1001 can communicate with a FAX apparatus 1031 via the PSTN/ISDN 1030. Also, an MFP 1040 is connected on the LAN 1010, and can print out an image read by the MFP 1001.

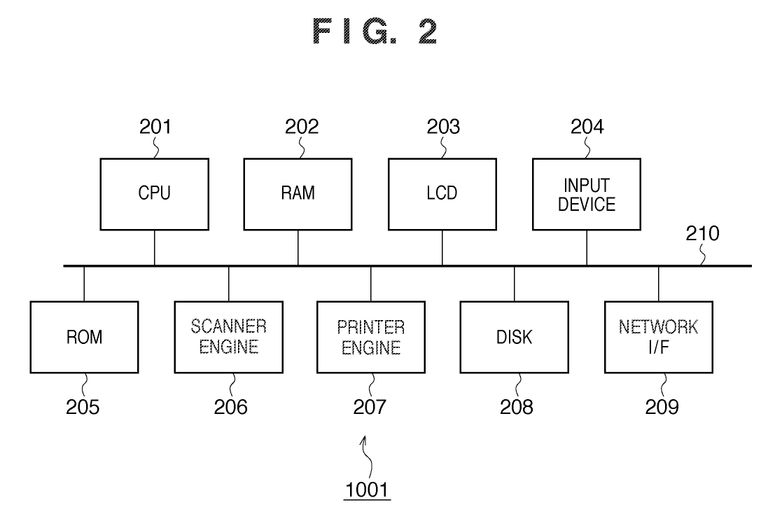

The hardware arrangement of the MFP 1001 as an image processing apparatus according to this embodiment will be described below with reference to FIG. 2. Note that the MFPs 1100 and 1040 have the same hardware arrangement as that of the MFP 1001, and a description thereof will not be given. As shown in FIG. 2, a CPU 201, RAM 202, LCD 203, input device 204, ROM 205, scanner engine 206, printer engine 207, DISK 208, and network I/F 209 are interconnected via a system bus 210.

Programs required to control the image processing apparatus are stored in the ROM 205 or DISK 208. These programs are read out onto the RAM 202 as needed and are executed by the CPU 201. The ROM 205 and DISK 208 store attribute information indicating functions and states of the image processing apparatus itself and jobs (image processes) to be processed by the image processing apparatus, job data to be output, and received and accumulated job data. Furthermore, the CPU 201 communicates with an external apparatus connected to a network via the network I/F 209. The network I/F 209 may include a wireless communication network such as USB, IEEE1394, or Bluetooth® in addition to an Ethernet® interface. Furthermore, the CPU 201 displays messages for the user and accepts inputs from the user via the LCD 203 and input device 204.

In this embodiment, in the MFP 1001, the CPU 201 receives a user input from the input device 204 via the system bus 210 to execute a corresponding process, unless otherwise specified. Also, the CPU 201 controls the RAM 202, LCD 203, ROM 205, scanner engine 206, printer engine 207, DISK 208, and network I/F 209 via the system bus 210 to execute processes.

The MFP 1001 can execute a scan job that reads a paper document using the scanner engine 206 and generates image data. Also, the MFP 1001 can execute a print job which outputs externally received data using the printer engine 207, and also a copy job which copies a paper document using the scanner engine 206 and printer engine 207.

Terms associated with processes of the MFP (image processing apparatus) according to this embodiment will be defined. Image processes such as print, scan, FAX sending, FAX receiving, document storage, and document sending processes will be referred to as jobs. A process for notifying a state change of a job indicating whether the job is waiting for execution, is being executed, completes processing, or is being interrupted will be referred to as a job state change notification. An event which includes, for example, a job state change, and occurs in the image processing apparatus will be referred to as an event. A process for notifying a notify destination, which is registered in advance, of occurrence of a predetermined event and event contents upon occurrence of the event will be referred to as an event notification. A request, which is registered in advance to send an event notification upon occurrence of an event, will be referred to as an event notify request.

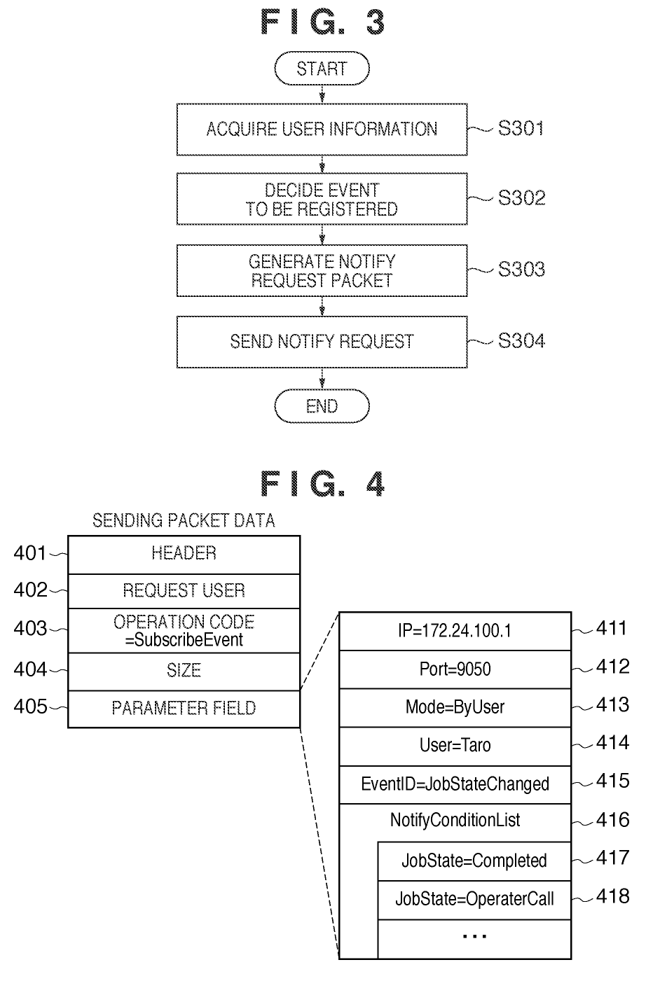

Processing executed when the MFP 1100 executes user authentication and allows the user to log in will be described below with reference to FIG. 3. Note that the user authentication may be executed by collating a user ID (user's identification information) and password input by the user or by collating authentication information in an input IC card. Note that authentication information (identification information) to be collated at the time of the user authentication is registered in the ROM 205 or DISK 208 in the MFP 1100 prior to the user authentication. Alternatively, the authentication information may be registered in the database server 1002 or an IC card (not shown). In this case, the MFP 1100 acquires the authentication information from the database server 1002 or IC card. Therefore, in the user authentication processing, the authentication information to be collated is loaded from the ROM 205, DISK 208, database server 1002, or IC card onto the RAM 202, and the loaded information is processed. Note that in the following description, numbers following “S” indicate step numbers in respective flowcharts. Also, in the following description, the MFP 1100 will be explained as a first image processing apparatus, and the MFP 1001 will be explained as a second image processing apparatus.

In step S301, the MFP 1100 acquires user information such as a user ID and user authorization of the user obtained by the user authentication from the ROM 205, DISK 208, database server 1002, or IC card. The acquired user information is temporarily stored in the RAM 202. In step S302, the MFP 1100 decides an event to issue a notify request. This embodiment will explain a job state change notification as an event to issue a notify request. However, the present invention is not limited to such specific event to issue a notify request. For example, the event to issue a notify request may be events that notify state changes of the scanner engine 206 and printer engine 207 in the MFP 1001 or that which notifies a state change of an application or a change of configuration information or setting values of the MFP 1100. The MFP 1100 may decide the event to issue a notify request by loading information, which is registered in advance, from the ROM 205, DISK 208, or database server 1002, or may prompt the user to designate it via the LCD 203 or input device 204. Also, the contents decided in step S302 may include designation of event notify conditions. The decided contents are temporarily stored in the RAM 202.

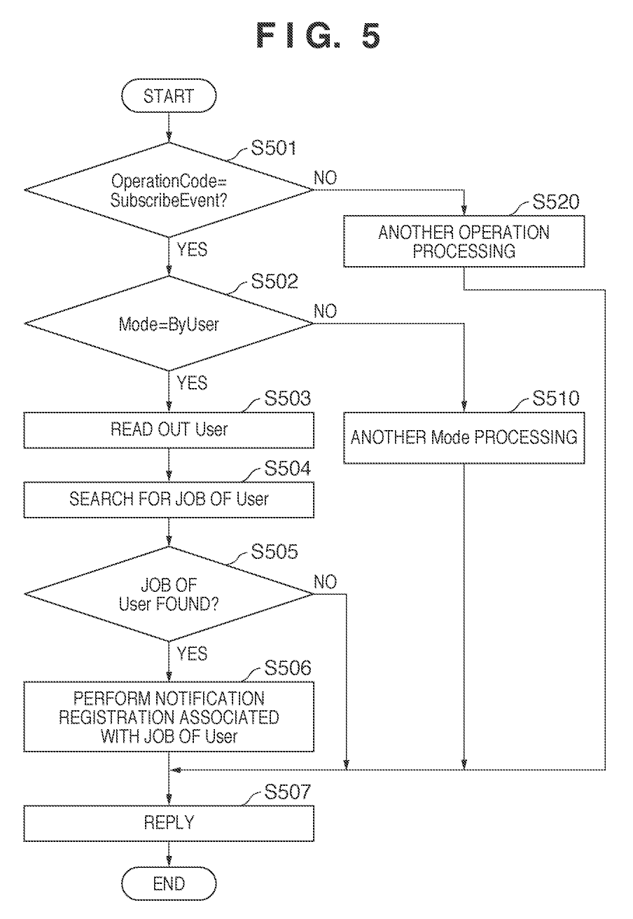

In step S303, the MFP 1100 serves as a packet generation unit, and generates a job state change notify request packet required to issue the job state change notify request decided in step S302. Details of the packet to be generated will be described later using FIG. 4. The generated packet is temporarily stored in the RAM 202. In step S304, the MFP 1100 serves as a packet sending unit, loads the job state change notify request packet generated in step S303 from the RAM 202, and broadcasts it in the LAN 1010 via the network I/F 209, thus issuing an event notify request. The packet generated in step S303 is sent to respective nodes in the LAN 1010 since it is broadcast. Processing on the receiving side will be described later using FIG. 5.

With the processing shown in FIG. 3, information indicating that notify processing is required when a state change of a job corresponding to the notify request has occurred is registered in the MFP 1001 in the LAN 1010, which can process the state change notify request of a job of the login user. Also, it is desirable for other image processing apparatus in the LAN 1010 to execute the same receiving processing as in the MFP 1001 and to register information indicating that notify processing is required when a state change of a job corresponding to the notify request has occurred. Assume that an apparatus in the LAN 1010, which cannot process the job state change notify request, merely ignores the notify request, and executes nothing.

Note that when a state change of a job occurred before the notify request is processed, the state change is not notified. For this reason, the MFP 1100 desirably executes processing for confirming whether or not the state change of the job of the login user already occurred at the login timing in addition to the user login processes shown in FIG. 3.

The configuration of the job state change notify request packet, which is generated in step S303 and is sent in step S304 by the MFP 1100, and which is received by the MFP 1001 and responds to the request will be described below with reference to FIG. 4. Note that the configuration of the job state change notify request packet shown in FIG. 4 is an example, and the configuration about contents, identifiers, and other details is not particularly limited upon practicing the present invention.

Reference numerals 401 to 405 denote fields in a basic structure of the packet. Reference numerals 411 to 418 denote details of a parameter field 405. The basic structure (fields 401 to 405) will be described first. A header field 401 stores information which includes a protocol identifier, protocol version, reply request flag, and packet index, and does not depend on an operation code 403. An apparatus which receives the packet shown in FIG. 4 sent from the MFP 1100 can judge whether or not it can process the protocol of the packet by checking the header field 401.

A request user field 402 indicates user information of the login user on the MFP 1100 when the job state change notify request packet shown in FIG. 4 is sent. For example, the request user field 402 stores the user information which is acquired and is stored in the RAM 202 by the MFP 1100 in step S301. Since the user information is stored, an image processing apparatus which receives the packet shown in FIG. 4 can judge the login user on an image processing apparatus from which the job state change notify request packet is received. An operation code field 403 stores a code required to identify an operation type in the protocol. For example, in case of the job state change notify request, the operation code field 403 stores “SubscribeEvent” indicating an event notify request. A size field 404 stores a size of the parameter field 405. Since the parameter field 405 is a variable-length field, the size field 404 stores the size of the parameter field. The parameter field 405 stores parameters corresponding to the contents of the operation code field 403. Information to be stored changes depending on the contents of the operation code field 403.

Details of the parameter field 405 will be described below using fields 411 to 418. An IP field 411 indicates designation of a notify destination IP address to be notified upon occurrence of an event. A Port field 412 indicates designation of a receiving port number of a node indicated by the IP field 411. In case of FIG. 4, the fields 411 and 412 indicate a notify request to a port number “9050” at an IP address “172.24.100.1”. A Mode field 413 indicates designation of a notify request mode in “SubscribeEvent”. When the Mode field 413 stores “ByUser”, it indicates a notify request to have the user as a key. The user is indicated by a User field 414. The User field 414 indicates designation of the user as the key of the notify request. “Taro” in the field 414 indicates that a notify request is issued only for jobs, the associated user of which is “Taro”. An EventID field 415 indicates designation of an event to issue a notify request, and “JobStateChanged” indicates designation of a job state change event. A NotifyConditionList field 416 stores a list of designated event notify conditions. The NotifyConditionList field 416 stores data required to narrow down actual notify conditions of a job state change. A field 417 indicates designation to notify when a job state transits to “Completed”. A field 418 indicates designation to notify when a job state transits to “OperatorCall”.

Processing executed when the MFP 1001 receives the event notify request packet shown in FIG. 4 will be described below with reference to FIG. 5. Note that the processing shown in FIG. 5 may be executed by another apparatus in the LAN 1010 in place of the MFP 1001.

The MFP 1001 reads out the contents of the operation code field 403 and determines in step S501 whether or not the operation code is “SubscribeEvent”. If the operation code is “SubscribeEvent”, the process advances to step S502; otherwise, the process advances to step S520 to execute processing unique to another operation. In step S520, the MFP 1001 executes processing corresponding to the operation code, and the process then advances to step S507.

The MFP 1001 reads out information in the Mode field 413 and determines in step S502 whether or not the notify request mode is “ByUser”. If the notify request mode is “ByUser”, the process advances to step S503; otherwise, the process advances to step S510. In step S510, the MFP 1001 executes processing corresponding to a notify request mode other than “ByUser”, and the process advances to step S507.

In step S503, the MFP 1001 reads out the designation of the user (for example, “Taro”) used as a notify request search key from the User field 414. The readout user designation is temporarily stored in the RAM 202. In step S504, since the notify request mode is “ByUser”, the MFP 1001 searches a job list managed by itself for a job, the associated user of which is “Taro”, and the process advances to step S505. Note that the associated user indicates a user who is stored as a job attribute and issued a job execution request. For example, if that job is a print job, the associated user is a user who logged in to a client PC when data was input from the client PC. Also, if that job is a copy job, the associated user corresponds to a login user who pressed a copy execution button from the input device 204 of the MFP 1001.

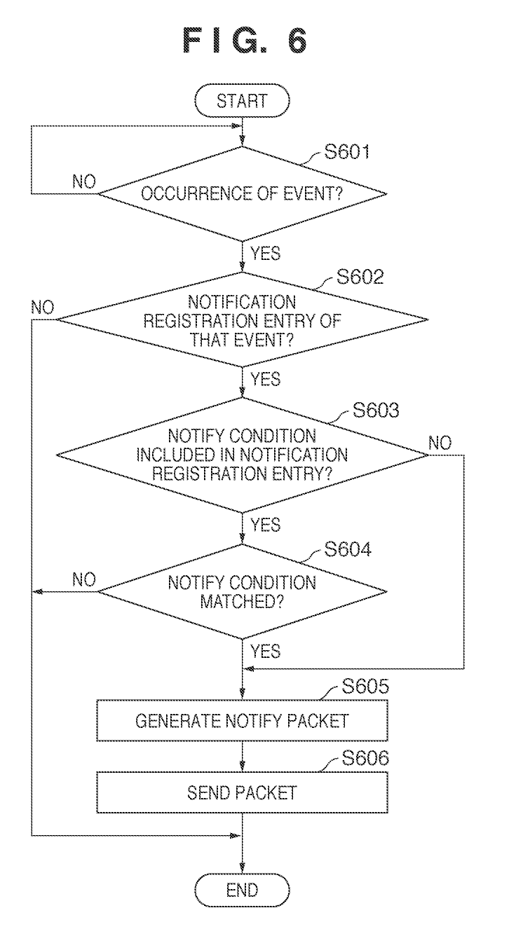

The MFP 1001 determines in step S505 whether or not a corresponding job is found as a result of the search in step S504. If the corresponding job is found, the process advances to step S506. If no corresponding job is found, the process jumps to step S507. In step S506, the MFP 1001 performs notification registration of a job state change event for the corresponding job. In the process executed in step S506, the MFP 1001 also performs notification registration of event notify conditions in the fields 417 and 418 together with an event identifier in the EventID field 415. Furthermore, the MFP 1001 performs notification registration of designated contents of the IP field 411 and Port field 412 of the event notify request packet as an event notify destination. Note that the event notification registration entry is stored in the RAM 202 or DISK 208. Details of the event notification processing will be described later using FIG. 6. Upon completion of the event notification registration, the process advances to step S507.

In step S507, the MFP 1001 replies the processing result to a sending source since the processing of the received packet is complete. The processing result in this case indicates normal or abnormal termination of the processing. However, when a reply request flag in the header field 401 is OFF, the MFP 1001 ends the processing without replying.

The sequence executed when the MFP 1001 detects and processes an event will be described below with reference to FIG. 6. Assume that in the processing to be described below, the MFP 1001 is executing a job of the user “Taro”, and has completed the event notification registration processing described using FIG. 5 upon reception of the event notify request packet shown in FIG. 4.

In step S601, the MFP 1001 repetitively determines the presence/absence of an event until an event is detected. If an event occurs, the process advances to step S602. The MFP 1001 determines in step S602 whether or not the event notification registration has been performed for the detected event. Since the event notification registration has already been done based on an event notify request, and its entry is stored in the RAM 202 or DISK 208, the MFP 1001 reads out that entry from the corresponding memory, and determines based on it. For example, upon detection of a job state change event, the MFP 1001 determines whether or not the event notification registration entry of the job state change event has already been stored. If the corresponding event notification registration entry has already been stored, the process advances to step S603; otherwise, the process ends.

Then, the MFP 1001 determines in step S603 whether or not the event notification registration entry determined in step S602 includes notify conditions. If the entry does not include any notify conditions, the process advances to step S605; otherwise, the process advances to step S604. In step S604, the MFP 1001 reads out the notify conditions from the event notification registration entry, and compares them with the detected event to determine whether or not the notify conditions are satisfied. For example, when the event notify request shown in FIG. 4 has been received and processed, and the event notify registration has already been done, the MFP 1001 determines if a job state of the detected job state change event is “Completed” or “OperatorCall”. If the event matches one of the registered event notify conditions, the process advances to step S605 to proceed with the event notification processing. On the other hand, if the event does not match any of the notify conditions, the process ends to skip the event notification processing.

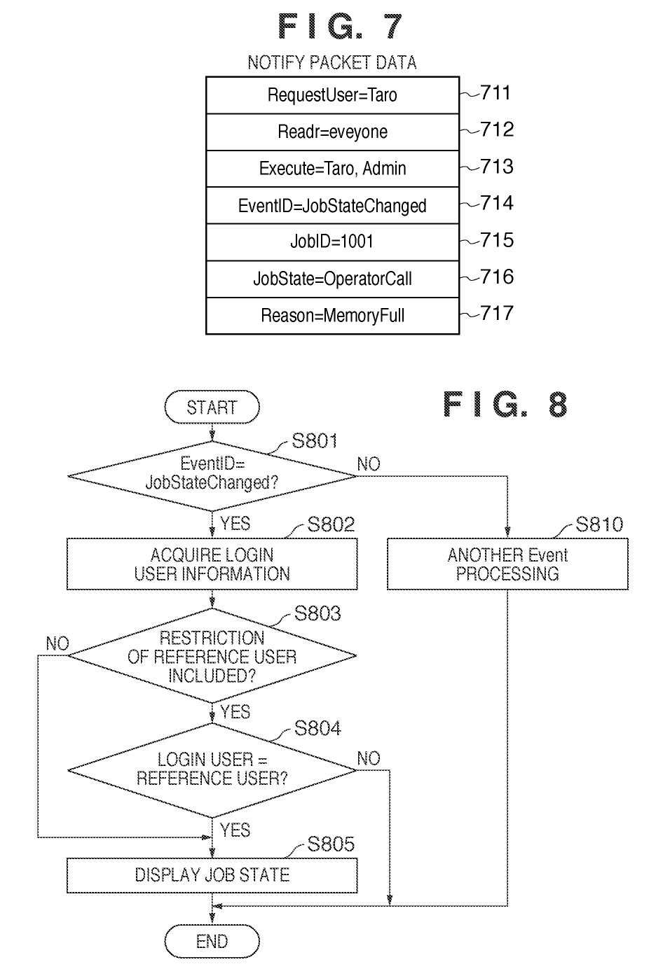

In step S605, the MFP 1001 generates a notify packet used to notify the detected event based on the event notification registration entry. Details of the notify packet to be generated will be described later with reference to FIG. 7. In step S606, the MFP 1001 sends the event notify packet generated in step S605 to the IP address and port number of the notify destination based on the event notification registration entry.

The configuration of the event notify packet, which is generated in step S605 of FIG. 6 and is sent in step S606 by the MFP 1001 will be described below with reference to FIG. 7. A request user field 711 indicates the login user on the MFP 1100 upon reception of the event notify request. A Read field 712 indicates a user and user group who have a reference authorization to a job, the job state change event of which is notified. In the field 712, “everyone” shown in FIG. 7 indicates that everyone can refer to that job. An Execute field 713 indicates a user and user group who have a job operation authorization of a job cancel operation and job transfer and interrupt operations of the job, the job state change of which is notified. For example, “Taro” set in the Execute field 713 is the user associated with the job, and is assigned the job operation authorization. Likewise, “Admin” is the user who has an administrator authorization, and is assigned the job operation authorization. In this way, according to this embodiment, access restriction information indicating the operation authorization and reference authorization with respect to the job (image processing) is appended to the event notify packet. An EventID field 714 indicates an identifier of the notified event. A JobID field 715 indicates an identifier of the job. By designating a job identifier=1001, a reference and operations associated with the notified job are allowed. A JobState field 716 indicates the state of the job. “OperatorCall” indicates occurrence of an error that requires an operator operation. A Reason field 717 indicates a reason associated with the contents of the JobState field 716. “MemoryFull” indicates occurrence of memory deficiency.

Note that the configuration of the event notify packet shown in FIG. 7 is an example used upon notifying the job state change event. Therefore, the packet may include other contents in addition to the aforementioned contents. For example, the packet may include a character string indicating a job name, and a display character string used when the event notify packet is received and displayed. Furthermore, the event notify packet may have different configurations depending on events to be notified. Also, the packet may have different configurations according to a state to be notified, and an event notify request which is registered in advance, even when an identical event is notified.

The sequence executed when the MFP 1100 receives and processes the job state change event notify packet shown in FIG. 7 will be described below with reference to FIG. 8. In step S801, the MFP 1100 reads out the contents of the EventID field 714 from the received event notify packet to determine whether or not the received packet indicates a state change event of the job, the notify request of which was issued. If it is determined that the received packet indicates the job state change event, the process advances to step S802; otherwise, the process advances to step S810. In step S810, the MFP 1100 executes processing for another event, and ends the processing. If an event which does not require any processing is received, the MFP 1100 discards the contents of the received event notify packet, and ends the processing.

In step S802, the MFP 1100 acquires user information of the current login user on itself. The MFP 1100 executes user authentication of the user in advance to make the user log in itself. For this reason, the user information can be acquired from the RAM 202, DISK 208, or database server 1002.

In step S803, the MFP 1100 serves as a reference determination unit, and reads out the contents of the Read field 712 from the received event notify packet to determine if the packet includes a restriction about a reference user. For example, if the value of the Read field 712 is “everyone”, the MFP 1100 determines that the packet does not include any restriction about a reference user. If the packet includes a restriction about a reference user, the process advances to step S804; otherwise, the process jumps to step S805. Since the packet includes a restriction about a reference user, the MFP 1100 determines in step S804 whether or not the current login user on itself acquired in step S802 has a reference authorization. If the user has a reference authorization, the process advances to step S805; otherwise, the process ends.

In step S805, the MFP 1100 serves as a display control unit, and displays a job state received by the event notify packet on the LCD 203 since the current login user can refer to an outline of the received event notify packet. For example, upon reception of the event notify packet shown in FIG. 7, the MFP 1100 displays that a memory deficiency error which requires an operator operation has occurred in the job indicated by the job identifier in the field 715. A condition required to display the event notification contents in detail may include only a case in which the user operates and selects such display via the LCD 203 and input device 204 of the MFP 1100. In this way, according to this embodiment, when the event notify packet is received, only a message indicating reception of the event notification is displayed, and details of the event notification contents are not displayed unless the user operates and selects such display.

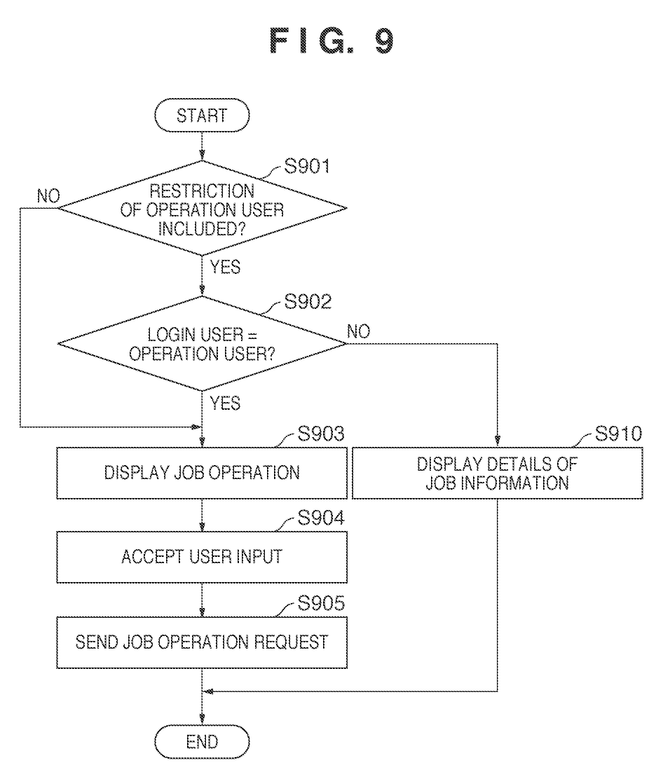

The processing executed when the MFP 1100 displays details of the event notification contents and performs a job operation according to a user's operation via the LCD 203 and input device 204 of itself after the processing in FIG. 8 will be described below with reference to FIG. 9. The MFP 1100 determines in step S901 with reference to the contents of the Execute field 713 of the notify packet shown in FIG. 7 whether or not the packet includes a restriction about an operation authorization in association with the corresponding job. For example, when the Execute field 713 includes a value “Taro, Admin”, it indicates that the packet includes a restriction about an operation authorization. If the packet does not include any restriction about an operation authorization, the process jumps to step S903; otherwise, the process advances to step S902.

In step S902, the MFP 1100 serves as an operation determination unit to determine whether or not the login user (a user-authenticated user) has an operation authorization. The MFP 1100 determines whether or not the user has an operation authorization by comparing the login user information acquired in step S802 and information in the Execute field 713. For example, if the user name is “Taro” based on the login user information, and the Execute field 713 includes a value “Taro, Admin”, the MFP 1100 determines that the login user has an operation authorization. If the MFP 1100 determines that the login user has an operation authorization, the process advances to step S903; otherwise, the process advances to step S910.

In step S910, since the login user cannot make any job operation, the MFP 1100 displays a display screen indicating the event detailed contents on the LCD 203 based on the contents notified by the job state change event notify packet shown in FIG. 7, thus ending the processing. The contents to be displayed includes a message indicating that the job suspends due to an operator call, and a job ID. On the other hand, in step S903, since the login user can make a job operation, the MFP 1100 displays an operation screen for prompting the user to select a job operation via the LCD 203. The contents to be displayed on the operation screen are different from those displayed in step S910 in that at least buttons which allow the user to select job operations including a job cancel operation and error skip operation are displayed. The contents to be displayed on the operation screen may include the information acquisition result from the MFP 1001 based on the event notification contents. Also, a selection button that allows the user to skip any operation may be displayed.

In step S904, the MFP 1100 serves as an accepting unit, and accepts a user instruction via the input device 204 with respect to the contents displayed on the operation screen. Upon accepting a user instruction, the MFP 1100 sends a job operation request based on the user input to the MFP 1001 in step S905. After that, the MFP 1100 receives a job operation request result sent from the MFP 1001, and displays the result for the user via the LCD 203. For example, when a job cancel request is sent, a result indicating as to whether or not to actually execute a job cancel operation is replied. The MFP 1100 receives that reply, and displays the result of job cancel processing, thus ending the processing.

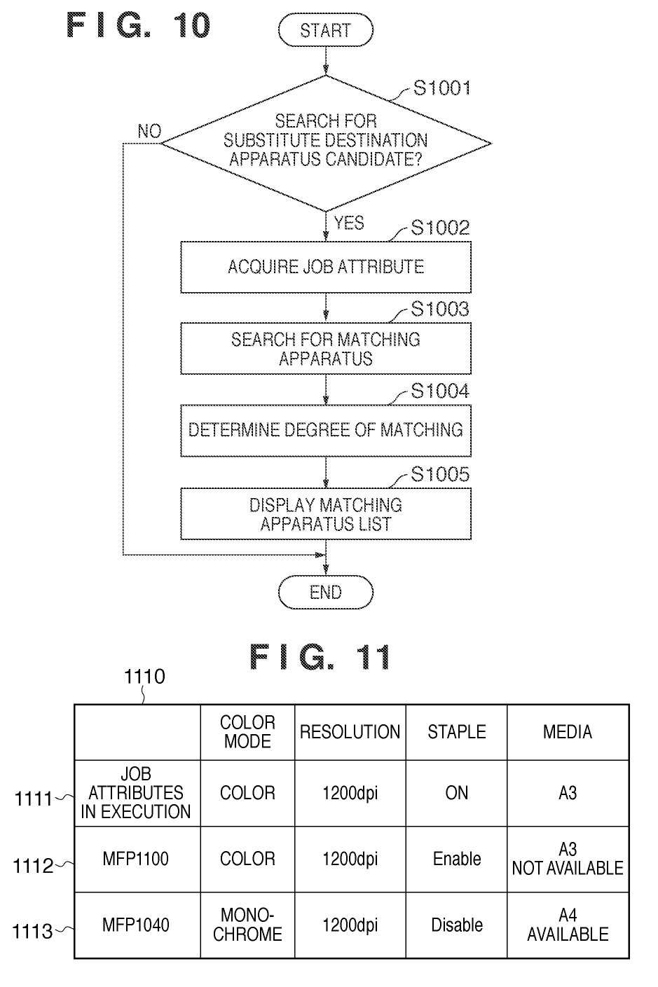

Processing of the MFP 1100 which searches for MFPs as job substitute destinations and can display them in step S903 of FIG. 9 when the job which is in execution by the MFP 1001 suspends due to, for example, an operator call will be described below with reference to FIG. 10. Note that the job substitution indicates that when a job which is in execution by the MFP 1001 suspends, another MFP (for example, the MFP 1100) re-executes the suspending job. The job substitute apparatus may discard whole contents of the suspending original job and then execute that original job from the very beginning, or may execute it from the sequel of the original job. Note that the job substitute destination indicates an MFP to which the job is entered later upon execution of the job substitution.

In step S1001, the MFP 1100 prompts the user to select whether or not to search for an MFP as a job substitute destination via the LCD 203 and input device 204. If the user selects to search for an MFP, the process advances to step S1002; otherwise, the process ends.

In step S1002, the MFP 1100 sends an attribute acquisition request of the event-notified job to the MFP 1001 so as to detect appropriate conditions of an MFP as a job substitute destination, and acquires attribute information of the job. The attribute information of the job indicates the processing contents of the job such as a color mode, reading resolution, staple processing setting ON/OFF, and media designation in case of, for example, a copy job. Assume that job attributes to be acquired to judge the MFP as a job substitute destination are registered in advance for respective job types, and are stored in the ROM 205 or DISK 208. For example, as for a print job, in order to detect a media designation to be used, a color mode, a print color mode, and the like, these job attributes are acquired. Also, as for a copy job, in order to detect a color mode and reading resolution decided based on an ACS (Auto Color Select) result of a document scan operation, these job attributes are acquired. The acquired job attributes are temporarily stored in the RAM 202. Details of attributes will be described later with reference to FIG. 11.

In step S1003, the MFP 1100 searches for a matching MFP based on the job attributes acquired in step S1002. Note that the MFP 1100 acquires capability information indicating an image processing capability of each MFP in the LAN 1010 prior to the search. For example, in case of a copy job, information indicating availability of a color scan function, a readable resolution, availability of a staple function, and a set output paper size is acquired. The acquired capability information of each MFP in the LAN 1010 is temporarily stored in the RAM 202, and the process then advances to step S1004.

In step S1004, the MFP 1100 judges an MFP which can process the job to be substituted based on the job attributes acquired in step S1002 and the MFP capability information acquired in step S1003. More specifically, the MFP 1100 judges whether or not the MFP capability information acquired in step S1003 satisfies the job attributes acquired in step S1002. An MFP whose capability information is judged to satisfy the job attributes is that which can substitute the job without changing the settings of the job in execution. However, not all the job attributes need be satisfied, and whether or not to be able to execute the job to be substituted may be judged using only specific attributes. For example, in a copy job, only a color mode capability may be used in judgment as an indispensable attribute. In this case, other job attributes may be changed as needed in correspondence with the capability of the substitute MFP.

After that, in step S1005, the MFP 1100 displays a list of MFPs which are judged in step S1004 to satisfy the job attributes as job substitute destination candidates for the user via the LCD 203, thus ending the processing. In this manner, since job substitute destination candidates are displayed based on the job attributes and MFP capability information, the user can easily judge an appropriate MFP as another MFP which executes the job in execution by the MFP 1001.

The job attributes and MFP capability information to be acquired and referred to by the processes shown in FIG. 10 will be described below with reference to FIG. 11. A table 1110 shows a conceptual configuration of job attributes and MFP capability information to be referred to. In the following description, assume that a job in execution is a copy job.

Job attributes 1111 in execution indicate attributes of a job in execution by the MFP 1001, and information of job attributes to be acquired in step S1002. In the job attributes 1111 in execution, an ACS color mode=color, a reading resolution=1200 DPI, a staple designation=ON, and an output paper size=A3. On the other hand, reference numerals 1112 and 1113 denote pieces of capability information of the MFP 1100 and MFP 1040, respectively, which are to be acquired in step S1003. The capability information 1112 indicates that a color scan function is available, a reading resolution=1200 DPI, a staple designation=enable, and media do not include any A3 paper in the MFP 1100. The capability information 1113 indicates that a monochrome scan function is available, a reading resolution=1200 DPI, a staple designation=disable, and media include A3 paper in the MFP 1040.

Whether or not to substitute the job in execution by the MFP 1001 can be judged in step S1004 based on the job attributes and respective pieces of MFP capability information in the table 1110. Furthermore, the respective pieces of MFP capability information shown in the table 1110 are referred to by the user via the LCD 203 in step S1004, thus presenting, to the user, information about an appropriate MFP as the substitute destination of the job.

As described above, according to this embodiment, the present invention is implemented as an image processing system in which first and second image processing apparatus are connected to be able to communicate with each other. The first image processing apparatus requests the second image processing apparatus to notify occurrence of a predetermined event when the user logs in. When the second image processing apparatus notifies the first image processing apparatus of occurrence of the predetermined event, the first image processing apparatus accepts an instruction for a job, the predetermined event of which occurs, from the login user, and sends the accepted instruction to the second image processing apparatus. Thus, the first image processing apparatus can receive and process a state change notification associated with the job which is in execution in the second image processing apparatus. Furthermore, the first image processing apparatus allows to make only an appropriate display operation and user operation by judging them based on access restriction information included in the job state change notification and login user information. That is, according to the image processing system of this embodiment, upon reception of a predetermined event associated with a job which is in execution by another image processing apparatus, an image processing apparatus which received the event can suitably control subsequent processes.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-147949 filed on Jun. 22, 2009, which is hereby incorporated by reference herein in its entirety.

What is claimed is:

1. An image processing system in which a first image processing apparatus and a second image processing apparatus are connected to be able to communicate with each other,
the first image processing apparatus comprising:
an authentication unit that authenticates a user, and allows a user-authenticated user to log in to the first image processing apparatus;
an accepting unit that accepts, when the second image processing apparatus notifies occurrence of the predetermined event, an instruction for the job in which the predetermined event has occurred, from the user-authenticated user; and
a sending unit that sends, when the accepting unit accepts the instruction, the instruction to the second image processing apparatus, and
the second image processing apparatus comprising:
an event notifying unit that notifies, when the predetermined event has occurred in the job executed in the second image processing apparatus, the first image processing apparatus of occurrence of the predetermined event; and
a control unit that controls the job in which the predetermined event has occurred, based on the instruction sent by the sending unit.

2. The system according to claim 1, the first image processing apparatus further comprising
a request unit that requests, when the user-authenticated user authenticated by the authentication unit logs in to the second image processing apparatus, the second image processing apparatus to notify occurrence of a predetermined event in a job executed in the second image processing apparatus, wherein
the accepting unit accepts the instruction from the user-authenticated user in response to the request by the request unit,
the second image processing unit further comprising
a receiving unit that receives the request by the request unit, wherein
the event notifying unit notifies, when the receiving unit receives the request, the first image processing apparatus of occurrence of the predetermined event.

3. The system according to claim 2, wherein the second image processing apparatus comprises a judging unit that judges, based on identification information which is included in the request by the request unit and is used to identify the user, whether or not the user-authenticated user on the first image processing apparatus has an operation authorization of the job executed in the second image processing apparatus, and
when the judging unit judges that the user-authenticated user on the first image processing apparatus has the operation authorization of the job executed in the second image processing apparatus, the event notifying unit notifies occurrence of the predetermined event together with access restriction information indicating the operation authorization.

4. The system according to claim 3, wherein the first image processing apparatus comprises a display control unit that displays, when the access restriction information indicating the operation authorization is notified from the second image processing apparatus, an operation screen used to operate the job in which the predetermined event has occurred.

5. The system according to claim 2, wherein the request unit comprises:
a packet generation unit that generates a packet which includes at least user information indicating the user-authenticated user on the first image processing apparatus, and a notify destination of the predetermined event; and
a packet sending unit that sends, as the request, the packet generated by the packet generation unit to the second image processing apparatus.

6. The system according to claim 5, wherein the packet generation unit sets a notify condition upon occurrence of the predetermined event in the packet, and
when the predetermined event has occurred, and satisfies the notify condition, the event notifying unit notifies occurrence of the predetermined event.

7. The system according to claim 1, wherein the first image processing apparatus further comprises:
a unit that acquires, when the predetermined event notified by the event notifying unit indicates interruption of the job executed in the second image processing apparatus, attribute information indicating processing contents of the job from the second image processing apparatus;
a unit that acquires pieces of capability information indicating image processing capabilities of a plurality of image processing apparatus connected via a network;
a unit that decides based on the attribute information and the pieces of capability information whether or not the plurality of image processing apparatus are configured to process the job interrupted in the second image processing apparatus; and
a unit that selectably displays the image processing apparatus which is decided to be configured to process the interrupted job.

8. A control method of an image processing system in which a first image processing apparatus and a second image processing apparatus are connected to be able to communicate with each other, the method comprising:
controlling the first image processing apparatus by
controlling an authentication unit to authenticate a user, and to allow a user-authenticated user to log in to the first image processing apparatus,
controlling an accepting unit to accept, when the second image processing apparatus notifies occurrence of the predetermined event, an instruction for the job in which the predetermined event has occurred, from the user-authenticated user, and
controlling a sending unit to send, when the instruction is accepted in the controlling the accepting unit, the instruction to the second image processing apparatus; and
controlling the second image processing apparatus by
controlling an event notifying unit to notify, when the predetermined event has occurred in the job executed in the second image processing apparatus, the first image processing apparatus of occurrence of the predetermined event, and
controlling a control unit to control the job in which the predetermined event has occurred, based on the instruction sent in the controlling the ending unit.

9. The method according to claim 8, further comprising controlling the first image processing apparatus by,
controlling a request unit to request, when the user-authenticated user authenticated in the controlling the authentication unit logs in to the second image processing apparatus, the second image processing apparatus to notify occurrence of a predetermined event in a job executed in the second image processing apparatus, wherein
the controlling the accepting unit to accept the instruction from the user-authenticated user in response to the request in controlling the request unit,
controlling the second image processing apparatus by,
controlling a receiving unit to receive the request in the controlling the request unit, wherein
the controlling the event notifying unit to notify, when the request is received in the controlling the receiving unit, the first image processing apparatus of occurrence of the predetermined event.

10. A computer-readable storage medium storing a computer program for making a computer execute a control method of an image processing system according to claim 8.
